(19) United States
(12) Patent Application Publication
(10) Pub. No.: US 2008/0301000 A1
(43) Pub. Date: Dec. 4, 2008

(54) "System for Tracking Gift Preferences"

(76) Inventor: Joseph Roch, Milwaukee, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/126,904

(22) Filed: May 25, 2008

Related U.S. Application Data
(60) Provisional application No. 60/940,862, filed on May 30, 2007.

(51) Int. Cl. G06Q 30/00; G06F 17/30; G06F 7/06; G06F 15/16

(52) U.S. Cl. 705/26; 707/3; 709/203; 709/202; 707/102; 707/E17.014; 707/E17.005

(57) ABSTRACT

A system for tracking gift preferences of gift recipients to create a unique gift preference list for each user and allowing the unique gift preference lists to be displayed on a portable electronic device.

### CROSS-REFERENCE TO RELATED APPLICATIONS

This application claims priority to U.S. Provisional Patent Application No. 60/940,862 filed May 30, 2007.

### FIELD OF INVENTION

This invention relates generally to the field of tracking consumer preferences, and more specifically to an integrated system for tracking gift preferences of individual users to which may be viewed by gift purchasers.

### BRIEF DESCRIPTION OF DRAWINGS

FIGS. 1a and 1b show a top perspective view of two alternate embodiments of a device for viewing gift preferences entered by gift recipients.

FIG. 2 shows a diagram of one embodiment of an integrated system for tracking gift preferences.

FIG. 3 shows one embodiment of a method for tracking and viewing gift preferences.

FIG. 4 illustrates an exemplary embodiment of an interface for a gift purchaser to view gift preferences entered by gift recipients which may be included in some embodiments.

FIG. 5 illustrates an exemplary embodiment which includes a software interface for gift recipients to enter their gift preferences.

### BACKGROUND

A significant portion of all retail (including online) purchases are made by consumers to give as gifts. Many retail industry segments report that,in excess of twenty percent of their annual sales are related to Christmas gift purchases.

Consumers typically spend a high percentage of their disposable income on holiday gifts, and often defer purchases of items family members need or want to coincide with the holiday season.

The consolidated buying activity that takes place over the holidays is stressful to consumers who are pressured to make many gift purchases in a time frame of several days or weeks. Consumers must make buying decisions as to which gifts to purchase for various gift recipients, often without the benefit of data or input from the gift recipient. The process of determining gift preferences (even among family members) can be time consuming, and choices may not reflect recipient's actual preferences.

The pressure to complete the gift buying process has been reported to cause stress and uncertainty among consumers leading to hasty choices, anxiety, lost time and wasted funds on unused consumer products. Consumers are receptive to options that address their concerns of avoiding the purchases of unwanted gifts, overpriced gifts and desire to avoid the loss of time associated with returning gifts.

Gift cards and gift certificates have met with extraordinary success in the market place, indicating that consumers are very receptive to convenient and time saving gift-shopping alternatives. Specifically, gift cards allow consumers to reduce stress and time associated with gift purchases, and increase the likelihood that the gift item ultimately purchased by the gift recipient is something the consumer wants and needs. It is estimated that the majority of consumers purchase at least one gift card during the holiday season.

However, despite the convenience of gift cards, there are substantial disadvantages to relying on gift cards to increase the efficiency of shopping for gifts. One disadvantage is that wrapped gifts are traditional, and add to the holiday ambience. A wrapped gift is perceived as a more personalized gift selection. Gift cards may be cleverly packaged, but do not have the consumer appeal and traditional excitement associated with a wrapped gift. More importantly, it is estimated that approximately half of all gift card recipients lose or do not use the full amount of their gift cards due to loss of the cards, expiration of the cards, lack of time on the part of the recipient to redeem the card and/or the fact that the card is from a store which carries merchandise that the user may not want.

In addition to holiday shopping time constraints, consumers may experience time constraints related to purchasing of birthday gifts, gifts for events such as weddings, showers and graduations and any other occasion for which gifts are traditionally purchased. It is thus customary for a gift purchaser of a wedding gift to find out if and where the recipient is “registered,” etc. The gift purchaser is thus encouraged to purchase from a registry without the benefit of shopping for best price and value for a desired gift item (e.g., a kitchen appliance). It is desirable for gift purchasers to have access to information as to gift preferences in a context other than a registry with a particular store.

Both holiday and special/limited occasion gift shopping may require a gift purchaser to obtain (or guess) specific information about a gift recipient's preferences and to use this information at the point of making a purchase.

It is desirable to have a convenient method of obtaining and tracking information about a recipient's actual gift preferences to reduce time associated with gift shopping.

It is further desirable to have a system which allows a gift purchaser to track the preferences of various persons (“gift recipients”) in a manner which reduces time and stress associated with shopping for gifts.

It is further desirable to have a manner of tracking marketing data about gift preferences by encouraging consumers to use a system from which they derive a benefit by entering information.

For the purpose of promoting an understanding of the present invention, references are made in the text hereof to embodiments of a device for tracking gift item preferences. It should nevertheless be understood that no limitations on the scope of the invention are thereby intended. One of ordinary skill in the art will readily appreciate that modifications such as the size and shape, system components or method steps may vary. The inclusion of fewer and/or additional elements are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed system, structure, or manner.

It should be understood that the drawings are not necessarily to scale, emphasis instead being placed upon illustrating the principles of the invention. In addition, in the embodiments depicted herein, like reference numerals refer to identical or nearly identical structural elements in the various drawings.

Moreover, the term “substantially” or “approximately” as used herein may be applied to modify any quantitative representation that could permissibly vary without resulting in a change in the basic function to which it is related. For example, one embodiment of a device for tracking gift preferences is disclosed herein as having a substantially square top and bottom surface. The device for tracking gift preferences might permissibly be somewhat non-square, i.e., rectangular or another shape, and still be within the scope of the invention if its functionality is not materially altered

### DETAILED DESCRIPTION OF EMBODIMENTS OF THE INVENTION

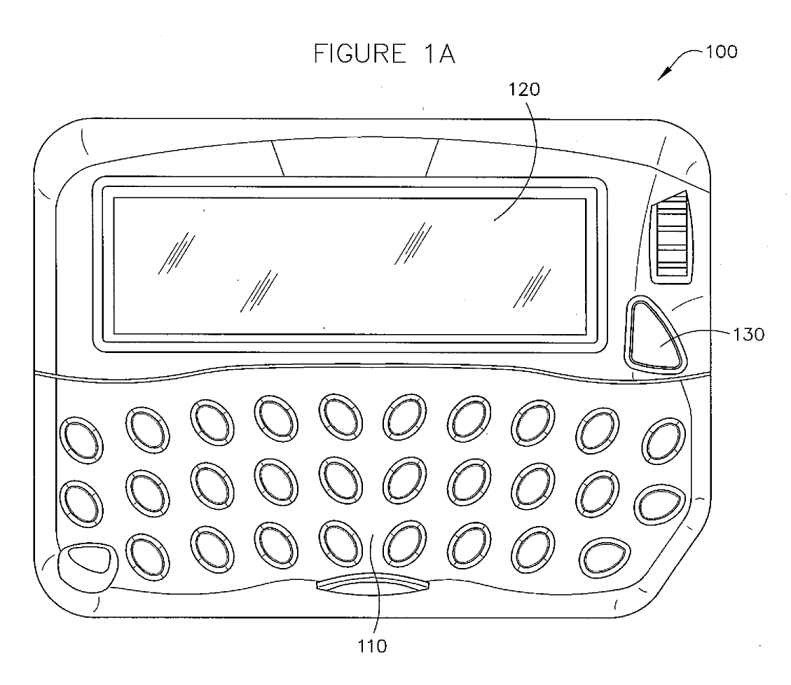

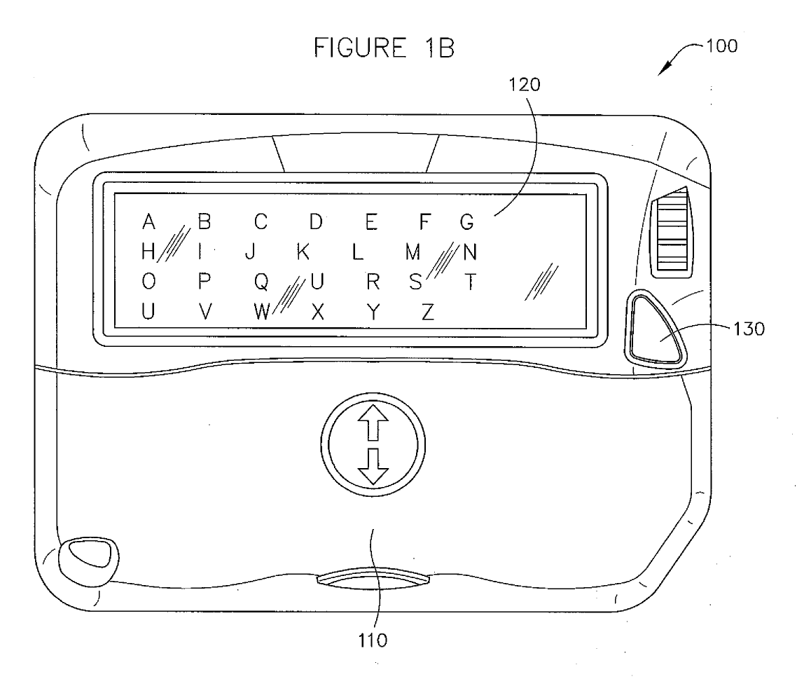

Referring now to the drawings, FIG. 1 a shows a top perspective view of one embodiment of a gift item tracking device 100. In the embodiment shown, gift item tracking device 100 comprises input device 110, user interface 120, and on/off switch 130. Gift item tracking device 100 also includes a component for storing information (e.g., gift lists for multiple gift recipients), i.e., a memory device (not visible). Device for tracking gift item preferences 100 further includes a power source, i.e., a battery (also not visible). In the embodiment shown, input device 110 is a keyboard and user interface 120 is an electronic or LCD screen.

Referring now to the drawings, FIG. 1b shows a top perspective view of an additional embodiment of a device for tracking gift item preferences 100. In the embodiment shown, gift item tracking device 100 comprises input device 110, user interface 120, and on/off switch 130. Gift item tracking device 100 also includes a component for storing information, i.e., a memory device (not visible). Gift item tracking device 100 further includes a power source, i.e., a battery (also not visible). In the embodiment shown, input device 112 is button which allows the user to make selections on viewable interface 120. In the embodiment shown, viewable interface 120 is an electronic or LCD screen which includes a digital display for inputting names of gift recipients to display their list of gift preferences. In the embodiment shown, a user selects a letter of the alphabet using input device 112, and this action updates viewable interface 120 to display a list of names (first or last) beginning with that letter, and then to select a specific name to again update the user interface. In the embodiment shown, a user may then use input device 112 to display a list of gift preferences corresponding to a gift recipient having the selected name.

Other embodiments of gift item tracking device 100 may include features which allow a user to enter the name of a new gift recipient (including themselves) and create a list for the new gift recipient using input device 112, or to update an existing list of gift preferences for a gift recipient that is already stored in the memory of gift item tracking device 100.

Still other embodiments of gift tracking device 100 may enable a user to track lists and gift preferences for multiple individuals or groups, and may enable a user to create lists of items to be purchased other than gifts (e.g., grocery lists, lists of items to be purchased for a project, inventory, school supply lists).

Some embodiments of gift tracking device 100 may have functionality limited to updating and displaying gift recipient preference lists. Other embodiments may have functionality to allow gift tracking device 100 to interact with a database stored on a computer (e.g., a user's computer or a remote server) to update gift recipient preference lists.

Further embodiments of gift tracking device 100 may include features for locating a seller of a preferred gift by connecting to the Internet, and mapping and budgeting tools to assist in the gift purchasing process. However, it is not necessary that embodiments of the invention include these features.

Further embodiments of gift item tracking device 100 may include large interfaces and/or keypads especially adapted for use by the elderly, handicapped, visually impaired or by young children.

Other embodiments of gift item tracking device 100 may include a touch sensitive pressure sensitive screen on which items may be handwritten or recorded.

Other embodiments of the invention may be personalized by color selection, graphical images, logos or other ornamentation.

Other embodiments of the invention may include a capability to print or e-mail a list or to communicate with other electronic devices.

While the device for tracking gift preferences has been shown and described with respect to several embodiments in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

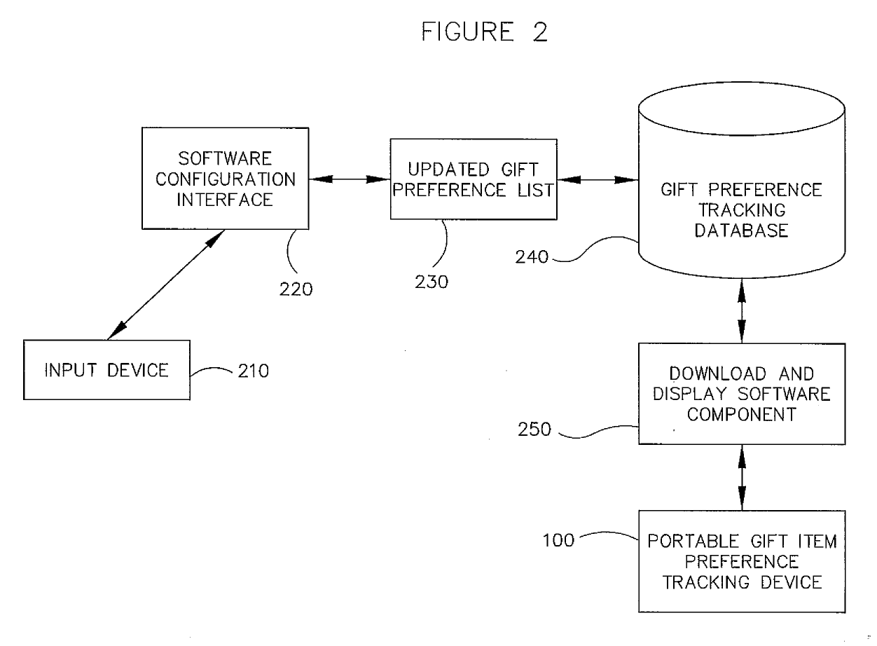

FIG. 2 shows one embodiment of gift preference tracking system 200 for tracking and viewing gift preferences and storing gift item preferences in memory. Using a keyboard or other input device 210, a user accesses software configured interface 220 which is a user interface used by a gift recipient to enter gift item preference data. Software configured interface 220 may be an interface created by software stored on a personal computer or may be the user interface of gift item tracking device 100 (as shown in FIGS. 1a and 1b).

The data entered by the user creates an updated gift preference list 230 which is displayed on software configured interface 220. Gift preference tracking database 240 is a database that tracks data related to gift purchases and recipients, including but not limited to the name(s) of gift recipients, gift preferences of gift recipients, lists of gift preferences, vendor information related to gift availability, geographical and socioeconomic data about gift purchasers and recipients, spending patterns and preferences or any other information which may be tracked related to gift purchasers and recipients entering their preferences into software configured interface 220.

In the embodiment shown in FIG. 2, gift tracking data base 240 resides on a server which users access via the Internet, but in other embodiments may be a database which resides on a personal computer or in the memory of tracking device 100 (as shown in FIGS. 1a and 1b).

In the embodiment shown, a user accesses software configured interface by registering and obtaining a password and/or a login which permits the user to create and update a list of gift preferences. Some embodiments of software configuration interface 220 may include merchant identifying information, links or other interface tools to allow a user to connect to a vendor or merchant or obtain information relevant to the availability, price or specifications of a gift preference item. Further embodiments may include tracking features to enable data entered by a gift recipient as to gift item preferences to be tracked for marketing and advertising purposes.

In the embodiment shown, gift tracking database 240 tracks the unique gift preferences entered for each gift recipient. In various embodiments, gift tracking database 240 may be searchable by names of gift recipients, and some embodiments may include various levels of password protection to restrict access to the list of each gift recipient to authorized users. Other embodiments may enable gift list recipients to maintain a list of users having authorized access to their gift list.

As also shown in FIG. 2, gift preference tracking system 200 further includes downloading and display software component 250 which further allows a list of gift preferences to be downloaded and displayed on gift item tracking device 100. Downloading software and display software component 250 may reside on the computer on which gift tracking preference database 240 is located, on a personal computer, on a server or on gift item preference tracking device 100. In the embodiment shown, gift item preference tracking device 100 is portable, so that a gift purchaser can view updated gift preference list 230 at the point of purchase (e.g., a store, a vendor location or while using their personal computer).

Further embodiments of gift preference tracking system 200 may include features which allow gifts on updated gift preference list 230 to be displayed in order of preference, display pricing information, display gift budgeting information (e.g. allow a gift purchaser to track and subtract the cost of each gift from a total gift budget amount), and may include wireless communication and mapping capabilities to locate vendors and confirm product availability.

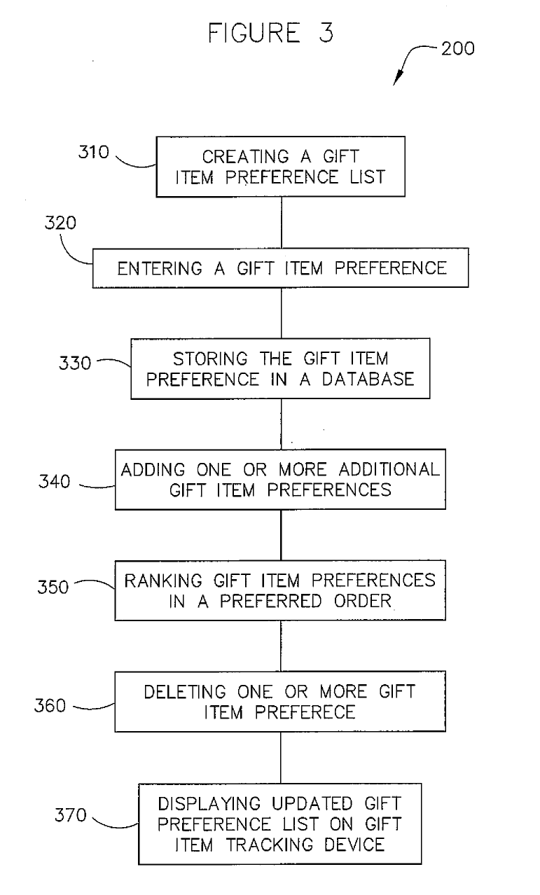

FIG. 3 depicts method 300 for electronically storing gift item preferences including at least two of the following steps. Step 310 is the step of creating a gift item preference list associated with a gift recipient. Step 320 includes entering a gift item preference which is stored in a gift tracking database. Step 330 (optional) includes storing the gift item preference in a remote or local database which is searchable by an identifier such a user name, family name, surname or login. Step 340 includes the optional step of adding one or more additional gift preference items to create an updated gift preference list. Step adding one or more additional gift item preferences and updating a gift preference list stored on a gift preference tracking database. Step. 350 (optional) includes ranking gift-item preferences in a preferred order. Step 360 includes the step of deleting one or more gift item preferences (optional). Step 360 includes the step of displaying an updated gift item preference list on gift item tracking device 100 (shown in FIG. 1) or other user interface (such as a computer interface, a printed list, a store registry, a mailing sent via U.S, mail, etc.). In the embodiment shown, step 360 is accomplished by downloading an updated list on gift item tracking device 100 (shown in FIG. 1) which may be used to retrieve and view one or more lists of identifiable gift recipients.

While the system for tracking gift item preferences and method for using same has been shown and described with respect to several embodiments in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

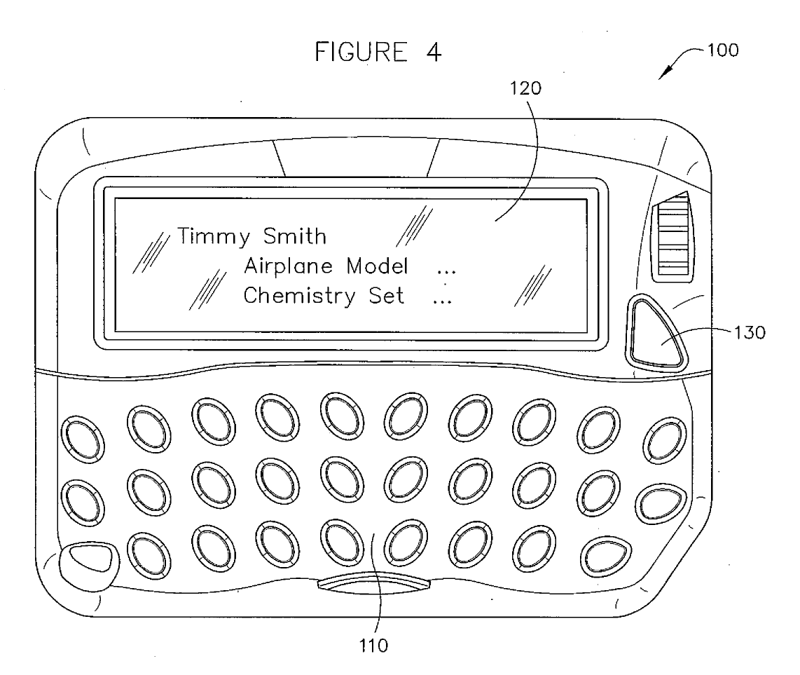

FIG. 4 illustrates an exemplary embodiment of an interface for a gift purchaser to view gift preferences entered by gift recipients which may be included in some embodiments.

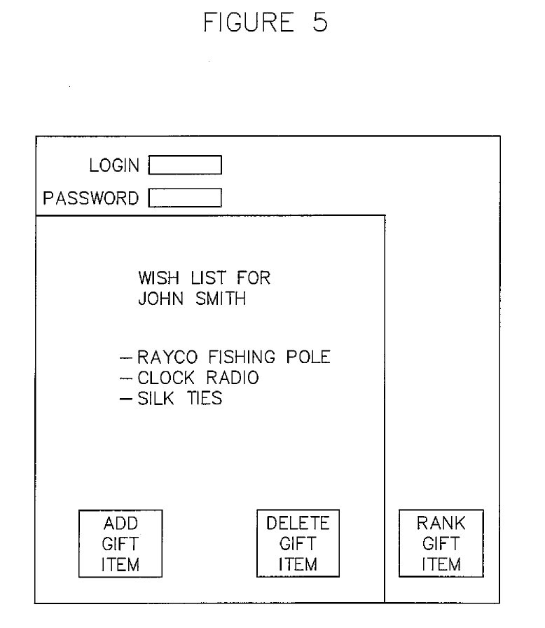

FIG. 5 illustrates and exemplary embodiment which includes a software interface for gift recipients to enter their gift preferences.

What is claimed is:

1. A gift tracking system comprised of:
a first user interface for entering gift preferences for at least one gift recipient to create at least one unique gift preference list; and
a portable device having a second user interface upon which a gift purchaser may view said unique gift preference list for said at least one gift recipient.

2. The system of claim 1 which further includes a searchable database used to locate and display a unique gift preference list for a specific user.

3. The system of claim 1 which further includes a portable device on which a least one unique gift preference list can be displayed, said device which is configured solely to store and display lists.

4. The system of claim 1 wherein said first user interface is displayed on a personal computer and can be used by at least one gift recipient to update at least one unique gift preference list which can be viewed by a gift purchaser.

5. The system of claim 1 wherein said at least one unique gift preference list can be downloaded onto said portable device.

6. The system of claim 1 which further includes a remote database which tracks gift preferences for multiple gift recipients.

7. The system of claim 6 which further includes a remote database which tracks gift preferences for multiple gift recipients, said remote database capable of being accessed by said portable device.

8. The system of claim 6 wherein said database tracks additional user data selected from a group consisting of user name, gift preference item, price range, geographical location of user, price range, and other socioeconomic data of users.

9. The system of claim 7 wherein said database which further provides a user with data selected from a group consisting of vendor information, vendor location information acquired from a map, the amount available in the user's gift budget and price comparison information.

10. A gift tracking system comprised of:
a first user interface for entering gift preferences for at least one gift recipient to create at least one unique gift preference list; and
a second user interface located on a portable electronic device which displays said at least one unique gift preference list for said at least one gift recipient.

11. The system of claim 10 wherein said portable electronic device includes an input device selected from a group consisting of a keyboard, a button for selecting letters of the alphabet from a screen and a touch screen.

12. The system of claim 10 which further includes a means for transferring data from a gift tracking preference database to said portable electronic device selected from a group consisting of a cord, a cable a memory card and electronic communication.

13. The system of claim 10 which further includes electronic communication capability for communicating gift preferences to vendors.

14. The system of claim 10 which further includes electronic communication capability for automatically generating vendor queries.

15. A method for tracking gift preferences comprising the steps of:
Creating a gift item preference list for at least one user
entering at least one gift item preference on a user interface on said gift item preference list;
storing at least one unique gift item preference list in at least one gift item preference list database; and
displaying an updated gift preference list on a user interface selected from a group consisting of a computer interface, paper, an e-mail, an instant message, a store registry or U.S. mail correspondence.

16. The method of claim 15 wherein said gift item which further includes the step of updating said unique gift item preference list by entering at least one user option selected from a group consisting of adding a said at least one gift item preference, ranking said at least one gift item preference, annotating said at least one gift item preference, deleting said at least one gift item preference to create an updated gift item preference list.

17. The method of claim 15 which further includes the step of downloading at least one gift item preference list onto at least one portable electronic device configure to display at least one unique gift item preference list.

18. A portable device for displaying gift item preference lists comprised of:
a user interface for displaying an individual gift preference list; and
a memory component used to update and store said at least one individual gift preference list which resides on a portable device with a viewable interface.

19. The device of claim 18, which is further capable of receiving data relating to at least one unique gift preference list that is downloaded from a database stored on a computer.

20. The device of claim 18 wherein viewable interface on said portable device includes an input device selected from a group consisting of a keyboard, a button for selecting letters of the alphabet from a screen and a touch screen.
